(19) United States
(12) Patent Application Publication
(10) Pub. No.: US 2009/0159412 A1
(43) Pub. Date: Jun. 25, 2009

(54) SIDE KEY ASSEMBLY AND PORTABLE ELECTRONIC DEVICE USING THE SAME

(75) Inventors: Ye Liu, Shenzhen City (CN); Hsiao-Hua Tu, Shindian (TW); Jun Wang, Shenzhen City (CN); Xin-Quan Zhou, Shenzhen City (CN); Wen-Wei Song, Shenzhen City (CN)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/146,590

(22) Filed: Jun. 26, 2008

(30) Foreign Application Priority Data
Dec. 24, 2007 (CN) 200710203361.6

(51) Int. Cl. H01H 19/06

(52) U.S. Cl. 200/302.3

(57) ABSTRACT

A side key assembly (10) and a portable electronic device (200) using the side key assembly (10) is provided. The side key assembly (10) includes a key cover (12), a soft portion (142) and a hard portion (144) that can be firmly adhered to a housing of the portable electronic device □200□. Using this structure, the opportunity for dust or water to enter the portable electronic device (200) is reduced.

### BACKGROUND

1. Field of the Invention

The present invention relates to side key assemblies, particularly a side key assembly used in portable electronic devices.

2. Description of Related Art

Many electronic devices such as mobile phones have housings with an interior compartment for receiving a printed circuit board therein. The mobile phone usually forms a side key assembly on an outside sidewall of the housing, so that a user can operate the mobile phone with one finger. Typically, the side key assembly includes a key cover and a key cap adhered to the key cover. The key cap is elastic. The key cap is distorted when an external force is exerted thereon, and then is restored to its original state when the external force is removed. The key assembly is disposed in a hole defined in an outer shell of the portable electronic device, thus a slight gap is formed between the key assembly and the outer shell. If the key assembly becomes wet, water and/or vapor could penetrate through the gap into the portable electronic device, affecting the circuit board. In addition, dust entering into the portable electronic device can also degrade performance

To avoid water or dust entering into the portable electronic device, a waterproof and/or dustproof structure is designed for the key assembly. Typically, the key assembly is wrapped by a waterproof and/or dustproof film. The wrapping process is complex and difficult to control. Moreover, the film can be easily damaged and then can no longer provide protection against water and dust. In addition, it is difficult to adhere the key cap of the keypad assembly to the outer shell.

Therefore, a new key assembly in order to overcome the above-described shortcomings needs to be provided.

### BRIEF DESCRIPTION OF THE DRAWINGS

Many aspects of the present keypad assembly and portable electronic device can be better understood with reference to the following drawings. These drawings are not necessarily drawn to scale, the emphasis instead being placed upon clearly illustrating the principles of the present keypad assembly and portable electronic device. Moreover, in the drawings like reference numerals designate corresponding parts throughout the several views. Wherever possible, the same reference numbers are used throughout the drawings to refer to the same or like elements of an embodiment.

FIG. 1 is an exploded view of a portion of a portable electronic device using a side key assembly according to an exemplary embodiment.

FIG. 2 is an assembled view of the portable electronic device shown in FIG. 1.

FIG. 3 is a partial cut-away view of the portable electronic device in FIG. 2.

FIG. 4 is an isometric and exploded view of the side key assembly shown in FIG. 1, showing one aspect thereof.

FIG. 5 is an isometric and exploded view of the side key assembly shown in FIG. 1, showing another aspect thereof.

FIG. 6 is an assembled view of the side key assembly shown in FIGS. 4 and 5.

### DETAILED DESCRIPTION OF THE EMBODIMENTS

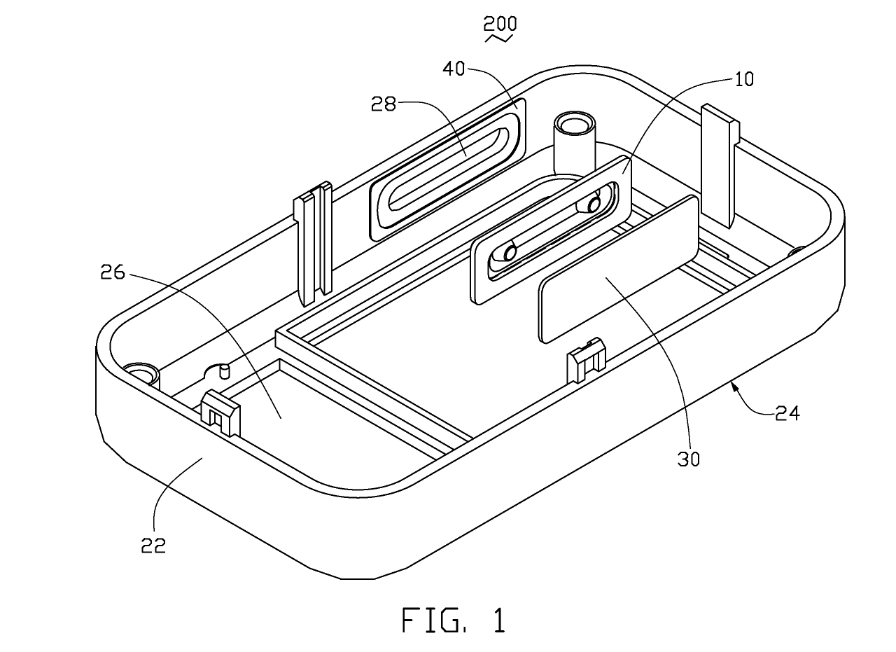

Referring to FIGS. 1, 2 and 3, a portion of a portable electronic device 200 includes a side key assembly 10, a housing 20, and a circuit board 30. The side key assembly 10 is assembled with the housing 20. The circuit board 30 is also assembled with the housing 20.

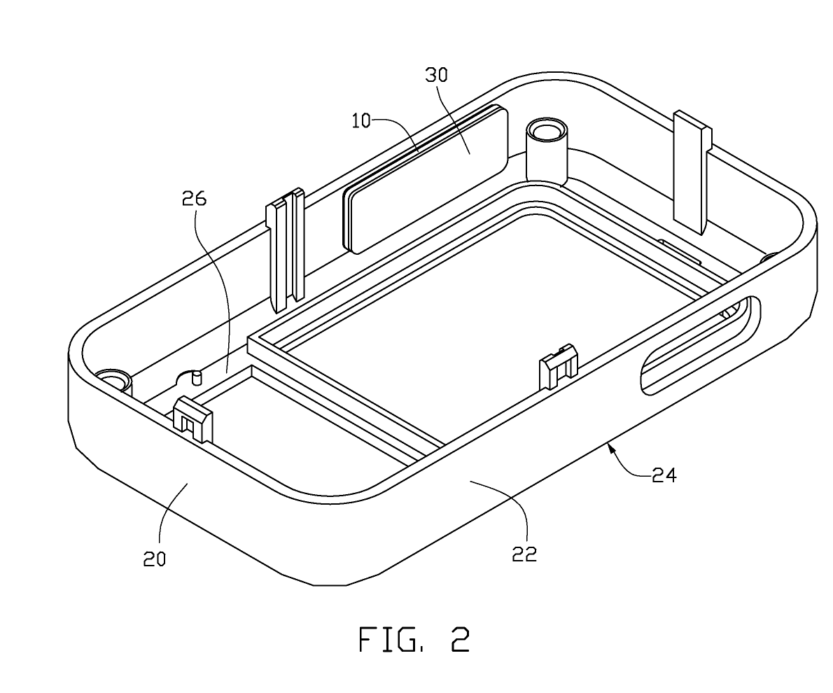

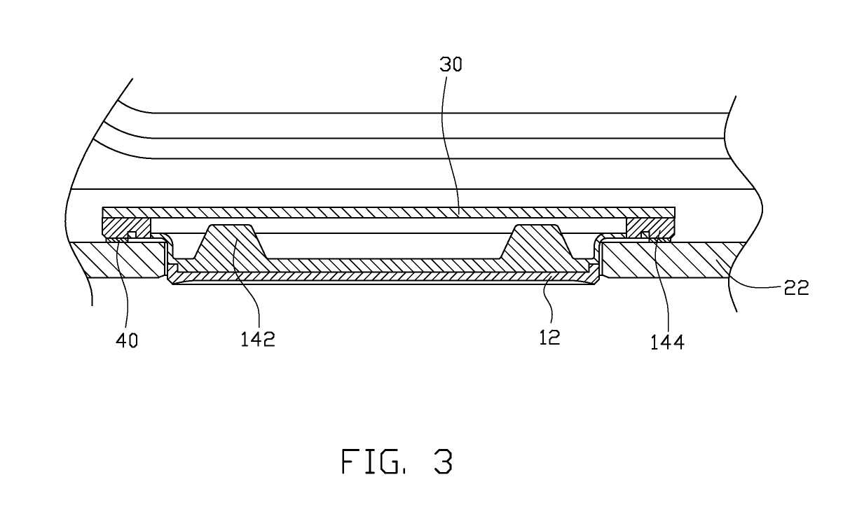

The housing 20 includes a peripheral wall 22 and a bottom panel 24. The peripheral wall 22 and the bottom panel 24 define a chamber 26. The circuit board 30 is disposed (e.g., bolted or adhered) on the peripheral wall 22 in the chamber 26. The peripheral wall 22 has a keyhole 28 defined therethrough. The side assembly 10, as assembled with the housing 20, is adhered to the peripheral wall 22 and partly accommodated in the keyhole 28, (FIGS. 2 and 3). Thus, the side key assembly 10 corresponds with the circuit board 30 for inputting information to the portable electronic device 200.

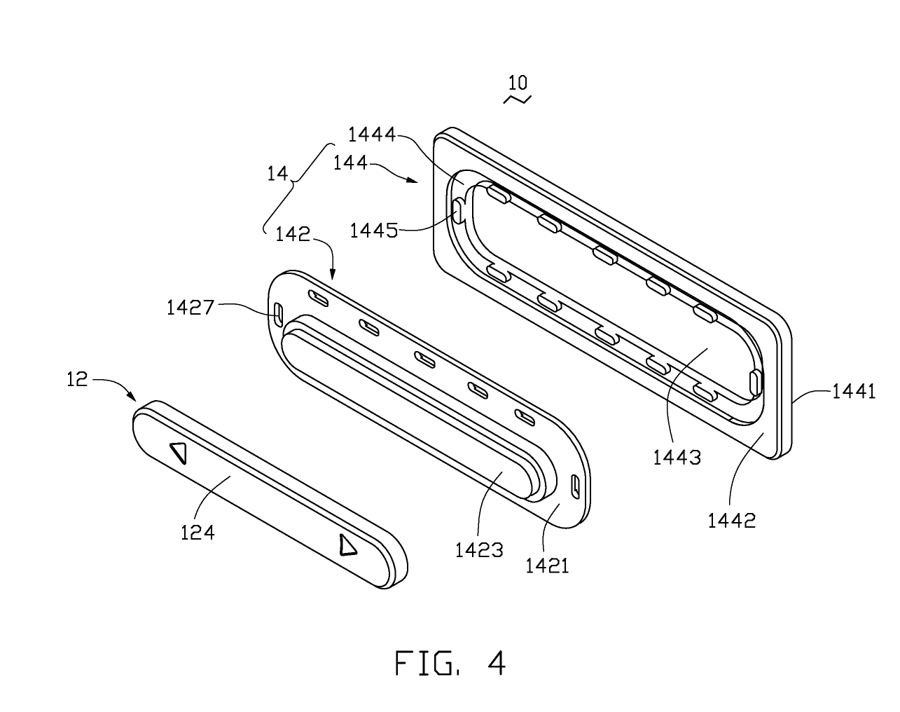

Referring to FIG. 4, the side key assembly 10 includes a key cover 12 and a key body 14.

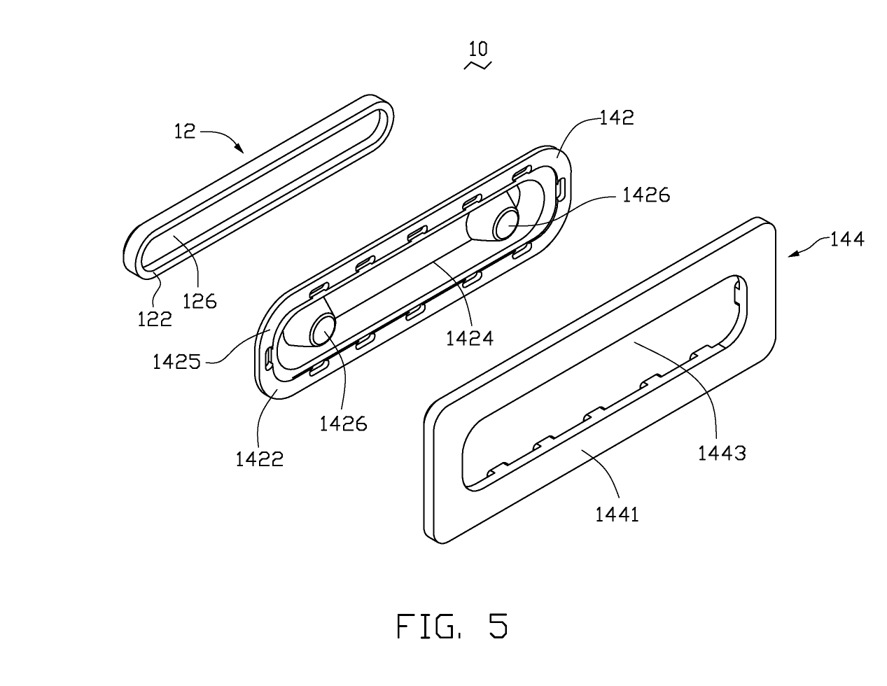

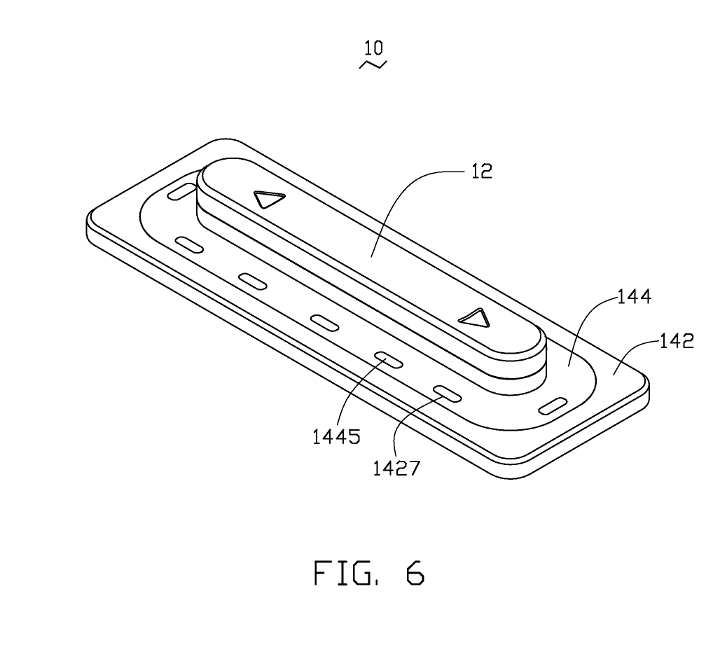

Referring to FIGS. 5 and 6, the key cover 12 is configured (e.g., structured/arranged) for accommodating the key body 14 therein and is generally a semi-enclosed shell with a raised edge 122 and a planar surface 124. The raised edge 122 and the planar surface 124 define a receiving space 126.

The key body 14 includes a soft portion 142 and a hard portion 144. The soft portion 142 is mounted to the hard portion 144.

The soft portion 142 is made of an elastic material (e.g., an elastic rubber material) so soft portion 142 can be distorted under an external force exerted thereon and restored to its original state upon release of the external force.

The soft portion 142 has a front surface 1421 and a rear surface 1422. The rear surface 1422 includes a projection 1423 thereon. The front surface 1421 defines a recess 1424 that corresponds to the projection 1423. The soft portion 142 further has a flange 1425 formed surrounding the projection 1423. Correspondingly, the flange 1425 surrounds the recess 1424 therein. The projection 1423 is disposed in the receiving space 126 of the key cover 12 to form an integral assembly.

The soft portion 1423 has a plurality of contacts 1426 protruding from the bottom surface (not labeled) of the recess 1424. The number of the contacts 1426 can be modified according to actual needs. The contacts 1426 correspond to conventional signal sensing points (not shown) of the circuit board 30. The contacts 1426 facilitate pressing the signal sensing points.

The flange 1425 has a plurality of mating holes 1427 defined therethrough. The mating holes 1427 are located around the projection 1423.

The hard portion 144 is made of a hard material (e.g., a hard plastic material) and has a first surface 1441 and a second surface 1442. The second surface 1442 is an attaching surface for attaching the hard portion 144 to the soft portion 142. The hard portion 144 has an aperture 1443 corresponding to the projection 1423. The aperture 1443 is substantially the same size and shape as the projection 1423. Correspondingly, the contacts 1426 can respectively penetrate through the aperture 144.

The hard portion 144 has a slot 1444 defined in the second surface 1442. The slot 1444 has substantially the same size and shape as the flange 1425. The slot 1444 accommodates the flange 1425.

A plurality of protrusions 1445 protrude from the bottom surface (not labeled) of the slot 1444. The protrusions 1445 of the hard portion 144 correspond with the mating holes 1427 so the mating holes 1427 can accommodate the protrusions 1445 therein.

Referring to FIGS. 4-6, during assembly of the side key assembly 10, the flange 1425 is adhered in the slot 1444. Then the protrusions 1445 are accommodated in the mating holes 1427. In this case, the soft portion 142 can be assembled integrally with the hard portion 144. Thus, water and dust cannot penetrate through the engaging surface between the soft portion 142 and the hard portion 144. After that, the projection 1423 is adhered into the receiving space 126. In use, because the hard portion 144 is made of a hard material, it can be firmly adhered to the housing 20.

Referring back to FIGS. 1 through 3, as the side key assembly 10 is assembled to the housing 20 of the portable electronic device 200, the key cover 12 and the soft portion 142 of the side key assembly 10 are partly disposed in the key hole 28 of the housing 20. The hard portion 144 of the side key assembly 10 is then adhered to the housing 20 of the portable electronic device 200 with glue 40. The glue 40 can be a waterproof glue to prevent water and dust from entering into the portable electronic device 200. In use, the side key assembly 10 is accommodated in the housing 20 of the portable electronic device 200 by the glue 40. More specifically, the hard portion 144 is made of a hard material, so the hard portion 144 can be firmly adhered to the housing 20 of the portable electronic device 200. Thus, the portable electronic device 200 has no gaps between the housing 20 and the side key assembly 10, thereby preventing water and dust from entering into the portable electronic device 200. As a result, the portable electronic device 200 has advantageous effects such as being waterproof and dustproof.

It is to be understood that the integrating means between the key cover 12 and the soft portion 142, and between the soft portion 142 and the hard portion 144 is not confined to glue. For example, the key cover 12, the soft portion 142 may be integrally molded onto the hard portion 144.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A side key assembly for use in a portable electronic device, comprising:
a key cover defining a receiving space;
a soft portion having a projection and a flange formed thereon that surrounds the projection, the projection disposed in the receiving space and formed integrally with the key cover; and
a hard portion including an attaching surface, the flange being attached to the attaching surface.

2. The side key assembly as claimed in claim 1, wherein the hard portion defines a slot on its attaching surface, the slot accommodating the flange.

3. The side key assembly as claimed in claim 2, wherein the hard portion has a plurality of protrusions protruding from a bottom surface of the slot, the soft portion has a plurality of mating holes, and the plurality of mating holes respectively correspond to the plurality of protrusions.

4. The side key assembly as claimed in claim 2, wherein the soft portion has a front surface positioned opposite to the hard projection, the soft portion having a plurality of contacts protruding from the front surface, the hard portion having a aperture defined therethrough, the aperture corresponding with the plurality of contacts.

5. The side key assembly as claimed in claim 1, wherein the flange is adhered to the attaching surface.

6. The side key assembly as claimed in claim 1, wherein the flange is integrally molded on the attaching surface.

7. A portable electronic device, comprising:
a housing;
a side key assembly assembled with the housing, the side key assembly comprising:
a key cover defining a receiving space;
a soft portion having a projection and a flange formed thereon, the flange surrounding the projection, the projection being disposed in the receiving space and formed integrally with the key cover; and
a hard portion including an attaching surface, the flange being attached with the attaching surface.

8. The portable electronic device as claimed in claim 7, wherein the hard portion defines a slot on its attaching surface, the slot accommodating the flange.

9. The portable electronic device as claimed in claim 8, wherein the hard portion has a plurality of protrusions protruding from a bottom surface of the slot, the soft portion has a plurality of mating holes defined therethrough, and the plurality of mating holes respectively correspond to the plurality of protrusions.

10. The portable electronic device as claimed in claim 8, wherein the soft portion has a front surface positioned opposite to the projection, the soft portion having a plurality of contacts protruding from the front surface, the hard portion having a aperture defined therethrough, the aperture respectively corresponding with the plurality of contacts.

11. The portable electronic device as claimed in claim 7, wherein the flange is adhered to the attaching surface.

12. The portable electronic device as claimed in claim 7, wherein the flange is integrally molded on the attaching surface.

13. The portable electronic device as claimed in claim 7, wherein the side key assembly is glued to the housing.

14. The portable electronic device as claimed in claim 13, wherein the glue is a waterproof glue.
